(19) United States
(12) Patent Application Publication
(10) Pub. No.: US 2021/0245436 A1
(43) Pub. Date: Aug. 12, 2021

(54) FEEDBACK CONTROL OF MICROWAVE ENERGY EMITTERS

(71) Applicant: Hewlett-Packard Development Company, L.P., Spring, TX (US)

(72) Inventors: David A. CHAMPION, Corvallis, OR (US); Douglas PEDERSON, Corvallis, OR (US); Peter J. KLAMMER, Corvallis, OR (US)

(73) Assignee: Hewlett-Packard Development Company, L.P., Spring, TX (US)

(21) Appl. No.: 17/052,100

(22) PCT Filed: Oct. 30, 2018
(86) PCT No.: PCT/US2018/058275

§ 371 Date: Oct. 30, 2020

(51) Int. Cl. B29C 64/282; B29C 64/393; B29C 64/153

(52) U.S. Cl. CPC B29C 64/282; B33Y 10/00; B29C 64/153; B29C 64/393

(57) ABSTRACT

According to examples, an apparatus may include an agent delivery device to deliver a coalescing agent to a selected location of a build material layer and a plurality of microwave energy emitters, each of which may include a tip to generate a focused microwave energy field onto a respective area near the tip. The apparatus may also include a controller that may control delivery of a first signal to a first microwave energy emitter of the plurality of microwave energy emitters; receive an energy feedback signal corresponding to energy reflected back into the first microwave energy emitter; determine, based on the received energy feedback signal, a power level of a second signal to be delivered to a microwave energy emitter of the plurality of microwave energy emitters; and control delivery of the second signal at the determined power level to the microwave energy emitter.

### BACKGROUND

In three-dimensional (3D) printing, an additive printing process may be used to make three-dimensional solid parts from a digital model. 3D printing may be used in rapid product prototyping, mold generation, mold master generation, and manufacturing. Some 3D printing techniques are considered additive processes because they involve the application of successive layers of material to an existing surface (template or previous layer). This is unlike traditional machining processes, which often rely upon the removal of material to create the final part. 3D printing may involve curing or fusing of the building material, which for some materials may be accomplished using heat-assisted melting, fusing, sintering, or otherwise coalescing, and then solidification, and for other materials may be performed through UV curing of polymer-based build materials or UV or thermally curable agents.

### BRIEF DESCRIPTION OF THE DRAWINGS

Features of the present disclosure are illustrated by way of example and not limited in the following figure(s), in which like numerals indicate like elements, in which:

FIG. 1 shows a diagram of an example apparatus that may include a plurality of microwave energy emitters having tips to generate focused microwave energy fields for focused build material coalescing and a controller for closed loop feedback control of signal delivery to the microwave energy emitters;

FIG. 2 shows a diagram of an example 3D fabrication system that may include the components of the apparatus depicted in FIG. 1;

FIG. 3 shows a bottom view of an example agent delivery device and an array of example microwave energy emitters shown in FIGS. 1 and 2;

FIG. 4 shows a diagram of an example energy emitter, an example microwave energy source, and an example power splitter;

FIGS. 5 and 6, respectively, show block diagrams of example apparatuses that may include a microwave energy emitter having a tip to generate a focused microwave energy field for focused build material coalescing and a controller for closed loop feedback control of signal delivery to the microwave energy emitter; and

FIG. 7 shows a flow diagram of an example method for closed loop feedback control of signal delivery to a microwave energy emitter.

### DETAILED DESCRIPTION

Disclosed herein are apparatuses and methods for fabricating 3D objects through selective coalescence of build material in build material layers. Particularly, the apparatuses may include an agent delivery device to deliver a coalescing agent to a selected location of a build material layer and a plurality of microwave energy emitters, in which each of the microwave energy emitters may include a tip to generate a focused microwave energy field. The coalescing agent may be selectively delivered onto locations of the build material layer that are to be coalesced, for instance, based on a 3D object model of an object to be fabricated. The apparatus may also include a controller that may control delivery of a first signal to a first microwave energy emitter of the plurality of microwave energy emitters to cause the first microwave energy emitter to emit a first microwave energy onto the build material layer, e.g., the selected location on the build material layer.

As the microwave energy is applied to the selected location, energy may be reflected back (or equivalently, returned) from the coalescing agent and/or build material at the selected location. The phase and amplitude of the reflected energy may be affected by the thermal mass of the coalescing agent and/or build material at the selected location. The thermal mass may depend on properties of the coalescing agent and/or build material at the selected location. The properties may include the type of the build material, the type of the coalescing agent, the density of the build material, the amount of coalescing agent applied at the selected location, the pattern of the coalescing agent applied at the selected location, a thermal history of the coalescing agent and/or the build material at the selected location, etc. In addition, the thermal mass of the coalescing agent and/or build material at the selected location may vary as the physical state of the coalescing agent and/or the build material at the selected location changes, e.g., as the coalescing agent becomes cured, as the build material melts, etc.

According to examples, the reflected energy may be directed back into the microwave energy emitter from which the first microwave energy was emitted. As discussed herein, the apparatus may include components that may isolate the reflected energy received by the microwave energy emitter and may determine a difference between the phase of the reflected energy and the phase of the first signal delivered to the microwave energy emitter. In addition, a controller may determine, based on the determined difference, a power level of a second signal to be delivered to a microwave energy emitter of the plurality of microwave energy emitters. The microwave energy emitter may be the microwave energy emitter that received the reflected energy or another microwave energy emitter. In any regard, the controller may control delivery of the second signal at the determined power level to the microwave energy emitter.

The apparatuses and methods disclosed herein, may control microwave energy emissions of a plurality of microwave energy emitters via a closed loop feedback control based on a property of energy reflected from coalescing agent and/or build material. The feedback control may also be based on a thermal mass of the coalescing agent and/or the build material. For instance, the power level of the second signal may be lower than the first signal when it is determined from the phase difference that the build material has begun to melt and/or that the coalescing agent has begun to cure. As another example, the power level of the second signal may be higher than the first signal when it is determined that the build material has not begun to melt as it should have.

Through implementation of the apparatuses and methods disclosed herein, microwave power levels emitted to coalesce build materials may be precisely controlled, in addition to precisely controlling the locations on a build material layer at which the microwave power is applied. In one regard, the precise control may result in better coalescing of the build material as the build material may be coalesced without overheating the build materials or the coalescing agent. As a result, 3D objects may be fabricated with uniform mechanical properties. In addition, the precise control may result in less build material aging and may thus enable the build material to be recycled with less degradation in quality.

Before continuing, it is noted that as used herein, the terms “includes” and “including” mean, but is not limited to, “includes” or “including” and “includes at least” or “including at least.” The term “based on” means “based on” and “based at least in part on.” In addition, references herein to melted particles may also be defined as including at least partially melted particles.

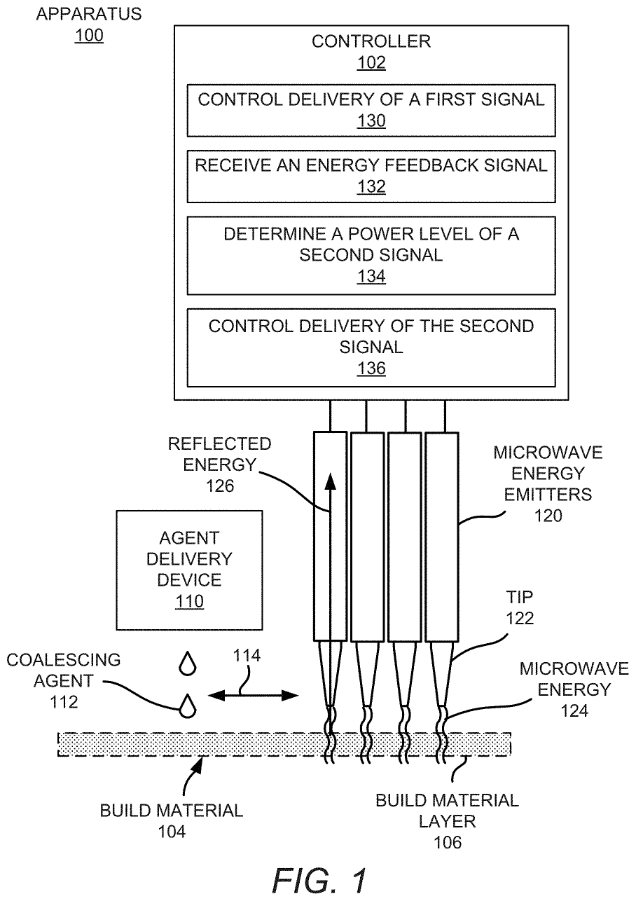

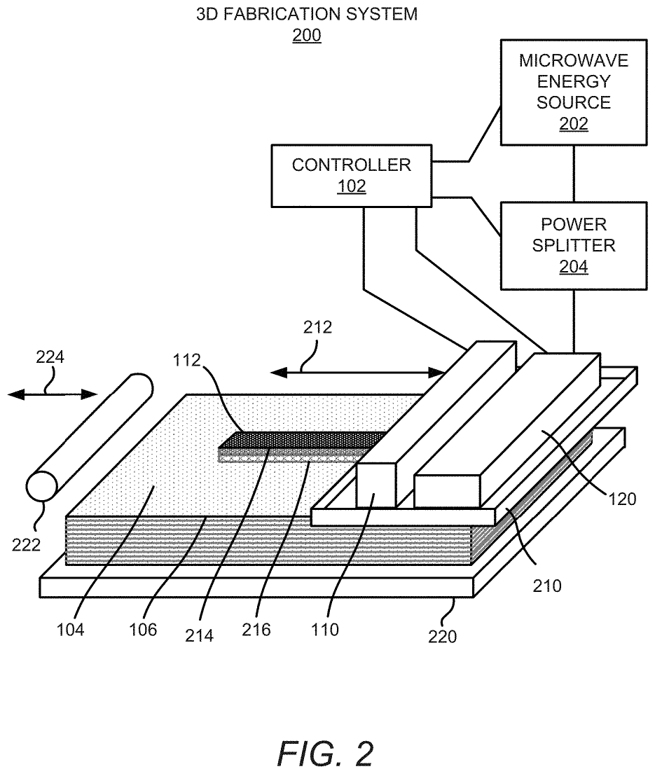

Reference is first made to FIGS. 1 and 2. FIG. 1 shows a diagram of an example apparatus 100 that may include a plurality of microwave energy emitters having tips to generate focused microwave energy fields for focused build material coalescing and a controller for closed loop feedback control of signal delivery to the microwave energy emitters. FIG. 2 shows a diagram of an example 3D fabrication system 200 that may include the components of the apparatus 100 depicted in FIG. 1. It should be understood that the apparatus 100 depicted in FIG. 1 and the 3D fabrication system 200 depicted in FIG. 2 may include additional components and that some of the components described herein may be removed and/or modified without departing from the scopes of the apparatus 100 and/or the 3D fabrication system 200 disclosed herein.

As shown in FIG. 1, the apparatus 100, which may also be a 3D fabrication system, may include a controller 102, which may be a computing device. In some examples, the controller 102 may be a semiconductor-based microprocessor, a central processing unit (CPU), an application specific integrated circuit (ASIC), a field-programmable gate array (FPGA), and/or other suitable hardware device. In some examples, the controller 102 may be separate from the apparatus 100 and/or the 3D fabrication system 200 while in other examples, the controller 102 may be incorporated with the apparatus 100 and/or the 3D fabrication system 200. The apparatus 100 and/or the 3D fabrication system 200 may also be termed a 3D printer, a 3D fabricator, or the like, and may be implemented to fabricate 3D objects from build material 104 as discussed herein.

The build material 104 may be formed into a build material layer 106 and the apparatus 100 and/or the 3D fabrication system 200 may cause build material 104 at selected locations of the build material layer 106 to coalesce. The selected locations of the build material layer 106 may include the locations that are to be coalesced to form a part of a 3D object or parts of multiple 3D objects in the build material layer 106. By selectively coalescing the build material 104 at selected locations on multiple build material layers 106, the parts of the 3D object or 3D objects may be fabricated as intended. As used herein, the term “coalesce” may be defined as being joined together through melting and subsequent fusing, through curing of a binder, etc.

As also shown in FIGS. 1 and 2, the apparatus 100 and the 3D fabrication system 200 may include an agent delivery device 110 that may deliver a coalescing agent 112 to the selected locations of the build material layer 106. For instance, the controller 102 may control the agent delivery device 110 to selectively deliver the coalescing agent 112 at the selected locations as the agent delivery device 110 is scanned across the build material layer 106 as denoted by the arrow 114. The apparatus 100 and the 3D fabrication system 200 may also include a plurality of microwave energy emitters 120, in which each of the microwave energy emitters 120 may include a tip 122 to generate a focused energy field 124 at a respective area near the tip 122. The tip 122 may be positioned sufficiently close to the build material layer 106 to place a portion of the build material layer 106 within the generated focused energy field 124. In addition, the tip 122 may have a relatively small diameter, e.g., between about 2 mm and about 4 mm, to focus the microwave energy 124.

According to examples, the energy 124 may be in the form of electromagnetic radiation. The electromagnetic radiation may have a wavelength that may be between about 1 meter and about one millimeter and may have a frequency that may be between about 300 MHz and about 300 GHz. As such, for instance, the energy 124, which is also referenced herein as microwave energy, may be in the microwave wavelength.

According to examples, the 3D fabrication system 200 may include a microwave energy source 202 that may supply energy (which may equivalently be termed signals) to the microwave energy emitters 120, in which power levels of the microwave energy emitted by the microwave energy emitters 120 may correspond to the power levels of the supplied energy. The microwave energy source 202 may include any suitable device that may generate microwave energy, such as a magnetron or multiple magnetrons, and may supply the generated energy to the microwave energy emitters 120 via a power splitter 204. The power splitter 204 may split the energy supplied from the microwave energy source 202 to each of the microwave energy emitters 120 such that the microwave energy emitters 120 may receive the same amount of energy with respect to each other. According to examples, the controller 102 may control the power splitter 204 to control which of the microwave energy emitters 120 are supplied with the energy at any given time. The microwave energy emitters 120 to which energy has been supplied may cause the focused energy field 124 to be generated near the tips 122 of the microwave energy emitters 120.

According to examples, the controller 102 may control 130 delivery of a first signal to a first microwave energy emitter 120 of the plurality of microwave energy emitters 120. The controller 102 may control delivery of the first signal to the first microwave energy emitter 120 at a time when the first microwave energy emitter 120 may be positioned to emit microwave energy 124 onto a location on the build material layer 106 at which the coalescing agent 112 has been applied.

The controller 102 may receive 132 an energy feedback signal corresponding to energy reflected back into the first microwave energy emitter 120. That is, as the microwave energy 124 is applied to the selected location, energy may be reflected back (or equivalently, returned) from the coalescing agent 112 and/or build material 104 at the selected location. The reflected energy is represented in FIG. 1 as the arrow 126. The phase and amplitude of the reflected energy 126 may be affected by the thermal mass of the coalescing agent 112 and/or build material 104 at the selected location. The thermal mass may depend on properties of the coalescing agent 112 and/or build material 104 at the selected location. The properties may include the type of the build material 104, the type of the coalescing agent 112, the density of the build material 104, the amount of coalescing agent 112 applied at the selected location, the pattern of the coalescing agent 112 applied at the selected location, a thermal history of the coalescing agent 112 and/or the build material 104 at the selected location, etc. In addition, the thermal mass of the coalescing agent 112 and/or build material 104 at the selected location may vary as the physical state of the coalescing agent 112 and/or the build material 104 at the selected location changes, e.g., as the coalescing agent 112 becomes cured, as the build material 104 melts, etc.

As discussed herein, a phase discriminator may determine the energy feedback signal, which may include a difference between a phase of the reflected energy 126 and the first signal supplied to the first microwave energy emitter 120. The phase discriminator may also communicate the determined energy feedback signal to the controller 102.

The controller 102 may determine 134, based on the received energy feedback signal, a power level of a second signal to be delivered to a microwave energy emitter 120 of the plurality of microwave energy emitters 120. In some examples, the microwave energy emitter 120 that may receive the second signal may be the first microwave energy emitter 120. In other examples, the microwave energy emitter 120 that may receive the second signal may be a second microwave energy emitter 120. The second microwave energy emitter 120 may be located downstream of the first microwave energy emitter 120 with respect to the scan direction 114. In still other examples, the controller 102 may cause the second signal to be delivered to both the first microwave energy emitter 120 and the second microwave energy emitter 120.

The controller 102 may control 136 delivery of the second signal at the determined power level to the microwave energy emitter 120. As such, for instance, the controller 102 may vary the level of microwave energy 124 applied to a location based on a detected property of the reflected energy 126, which may be affected by the state of the coalescing agent 112 and/or the build material 104 at the location from which the reflected energy 126 was received. In other words, the controller 12 may control the level of the microwave energy 124 applied based on a closed loop feedback, e.g., a property of the reflected energy 126.

The coalescing agent 112 may be a substance that may act as a catalyst for determining whether application of energy, e.g., energy in the microwave wavelength, results in the coalescing of the build material 104 on which the coalescing agent 112 has been applied. The coalescing agent 112 may be applied through use of a suitable agent delivery device 110. In addition, the locations at which the coalescing agent 112 may be applied may be areas of the build material layers 106 that may be coalesced to form portions of a 3D object or portions of multiple 3D objects. As such, multiple layers 106 may include selected areas of coalesced build material 104, such that the selectively coalesced build material 104 in the layers 106 may form the 3D object or objects.

According to examples, the coalescing agent 112 may enhance absorption of microwave energy from a plurality of microwave energy emitters 120 to heat the build material 104 to a temperature that is sufficient to cause the build material 104 upon which the coalescing agent 112 has been deposited to melt, fuse, cure, sinter, cause a reaction with another material, or otherwise coalesce prior to or as part of being joined. In addition, or alternatively, the coalescing agent 112 may be a binder that may absorb the microwave energy to become cured and thus cause the build material 104 upon which the coalescing agent 112 has been applied to become joined together as the coalescing agent 112 is cure. In addition, the microwave energy emitters 120 may apply energy at a level (and/or a wavelength) that may cause the build material 104 upon which the coalescing agent 112 has been applied to be coalesced without causing the build material 104 upon which the coalescing agent 112 has not been applied to be coalesced.

According to one example, a suitable coalescing agent 112 may be an ink-type formulation including carbon black, such as, for example, the coalescing agent 112 formulation commercially known as V1Q60A “HP fusing agent” available from HP Inc. In one example, such a coalescing agent 112 may additionally include an infra-red light absorber. In one example, such an ink may additionally include a near infra-red light absorber. In one example, such a coalescing agent 112 may additionally include a visible light absorber. In one example, such an ink may additionally include a UV light absorber. Examples of inks including visible light enhancers are dye-based colored ink and pigment-based colored ink, such as inks commercially known as CE039A and CE042A available from HP Inc. According to one example, the coalescing agent 112 may be a low tint fusing agent (LTFA).

In some examples, a detailing agent (not shown) may be applied on the build material layers 106 to assist in the formation of the portions of the 3D object in the build material layers 106. In some examples, the coalescing agent 112 may aid in the coalescing of the build material 104 on which the coalescing agent 112 has been applied while the detailing agent may define the boundaries at which the build material 104 coalesces. According to examples, the detailing agent may be a nonpolar and/or non-microwave absorbing detailing agent such that the application of the microwave energy from the microwave energy emitters 120 may not cause or may cause a relatively small amount of heating of the detailing agent.

The build material 104 may include any suitable material for forming a 3D object including, but not limited to, plastics, polymers, metals, nylons, and ceramics and may be in the form of a powder, a powder-like material, a fluid, a gel, or the like. References made herein to “powder” should also be interpreted as including “power-like” materials. Additionally, in instances in which the build material 104 is in the form of a powder, the build material 104 may be formed to have dimensions, e.g., widths, diameters, or the like, that are generally between about 5 μm and about 100 μm. In other examples, the build material 104 may have dimensions that may generally be between about 30 μm and about 60 μm. The build material 104 may generally have spherical shapes, for instance, as a result of surface energies of the particles in the build material and/or processes employed to fabricate the particles. The term “generally” may be defined as including that a majority of the particles in the build material 104 have the specified sizes and spherical shapes. In other examples, the term “generally” may be defined as a large percentage, e.g., around 80% or more of the particles have the specified sizes and spherical shapes. The build material 104 may additionally or alternatively include short fibers that may, for example, have been cut into short lengths from long strands or threads of material. According to one example, a suitable build material 104 may be PA12 build material commercially known as V1R10A “HP PA12” available from HP Inc.

As further shown in FIG. 2, the 3D fabrication system 200 may include a carriage 210 on which the agent delivery device 110 and the microwave energy emitters 120 may be supported. The carriage 210 may be scanned across the build material layer 106 as denoted by the arrow 212. In some examples, the controller 102 may control the agent delivery device 110 to selectively deliver the coalescing agent 112 to a selected location 214 of the build material layer 106 as the carriage 210 is scanned across the build material layer 106. The selected location 214 may include build material 104 that is to be coalesced to form a portion of a 3D object. In addition, the controller 102 may control the microwave energy emitters 120 to selectively direct energy 124 onto the selected location 214 of the build material layer 106 at which the coalescing agent 112 has been delivered. Although the agent delivery device 110 and the microwave energy emitters 120 are depicted as being supported on the same carriage 210, in other examples, the 3D fabrication system 200 may include multiple carriages 210 and the agent delivery device 110 and the microwave energy emitters 120 may be supported on separate carriages 210 such that the agent delivery device 110 and the microwave energy emitters 120 may separately be scanned across the build material layer 106 with respect to each other.

As shown in FIG. 1, the tips 122 of the microwave energy emitters 120 may be positioned in relatively close proximities to the build material layer 106 such that the build material 104 in the build material layer 106 may be within the energy fields 124 generated from the tips 122. According to examples, the build material 104, frequency, and/or the wavelength of the generated energy 124 may be selected such that the energy 124 may have a minimal heating effect on the build material 104. That is, for instance, the build material 104 may not absorb a large amount of the energy 124 and instead, a majority of the generated energy 124 may pass through the build material 104. As a result, the build material 104 may be maintained at relatively lower temperatures during receipt of the emitted microwave energy 124 as compared with configurations in which another type of energy, e.g., infrared energy, or other energy that the build material 104 may absorb, is applied to the build material 104. In one regard, by maintaining the temperature of the build material 104 relatively lower, the build material 104 may be reused in more fabrication jobs, e.g., recycled, with a lesser degree of degradation that may lead to lower quality builds.

In addition, the coalescing agent 112, frequency, and/or the wavelength of the generated energy 124 may be selected such that the energy 124 may have a large or maximum heating effect on the coalescing agent 112. That is, for instance, the coalescing agent 112 may absorb a large amount of the generated energy 124 and may become heated to a level that may cause the build material 104 on which the coalescing agent 112 has been applied to melt, fuse, sinter, or otherwise coalesce when the energy 124 is applied on the coalescing agent 112, and/or the coalescing agent 112 to be cured. Some of the microwave energy 124 may, however, pass through the coalescing agent 112 and the build material 104 to a layer 106 or to multiple layers 106 beneath a current build material layer 106. As a result, coalescing agent 112 applied to the lower layer 106 or layers 106 may also receive the energy 124 and may be heated while the coalescing agent 112 on a current layer 106 is being heated. The coalescing agent 112 in the lower layer(s) 106 may thus be heated for longer durations of time than during the time at which the lower layer(s) 106 were the current layer(s) 106. This may result in greater repetition between another portion 216 of the 3D object formed in a previous layer 106 that may be underneath a current layer 106 and the portion 214 of the 3D object being formed in the current layer 106, which may result in a stronger bond between the portions 214 and 216.

As also shown in FIG. 2, the 3D fabrication system 200 may also include a build platform 220 and a spreader 222. According to examples, the controller 102 may control the spreader 222 to apply layers 106 of build material 104 on the build platform 220 and the build platform 220 may be moved downward as the layers 106 are applied over the build platform 220. The build material 104 may be supplied between the spreader 222 and the build platform 220 and the spreader 222 may be moved in either or both directions represented by the arrow 224 across the build platform 220 to spread the build material 104 into a layer 106. The layers 106 have been shown as being partially transparent to enable the portions 214 and 216 to be visible. It should, however, be understood that the build material 104 may not be transparent or translucent, but instead, may be opaque.

Although not shown, the 3D fabrication system 200 may include a heater to maintain an ambient temperature of a build envelope or chamber within which the 3D object may be fabricated from the build material 104 at a relatively high temperature. In addition or in other examples, the build platform 220 may be heated to heat the build material 104 to a relatively high temperature. The relatively high temperature may be a temperature near the melting temperature of the build material 104 such that a relatively low level of energy 124 may be applied to selectively coalesce the build material 104 at the selected locations 214, 216. The 3D fabrication system 200 may also include an additional agent delivery device to deliver other agents, such as, for instance, coloring agents to the build material 104.

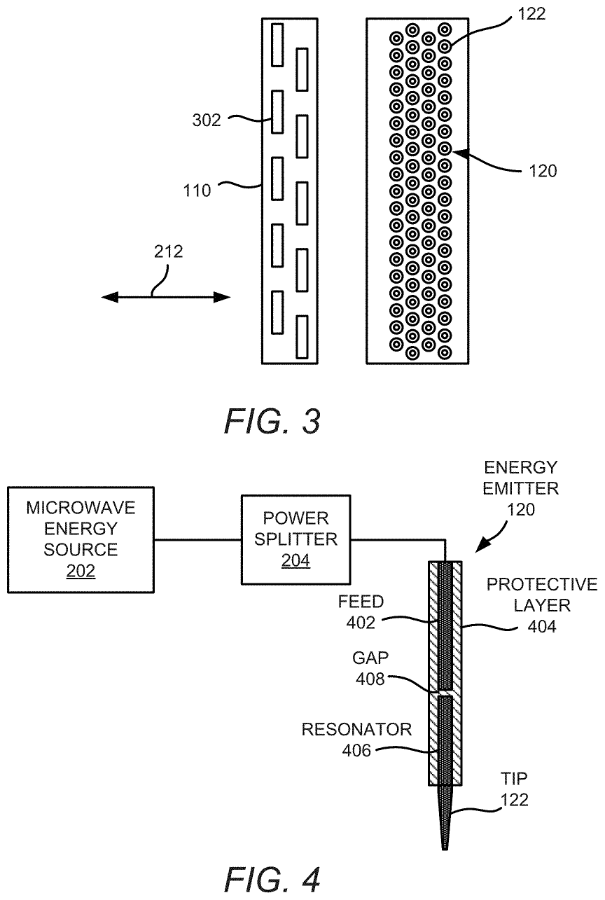

Turning now to FIG. 3, there is shown a bottom view of an example agent delivery device 110 and an array of example microwave energy emitters 120 shown in FIGS. 1 and 2. It should be understood that the example agent delivery device 110 and the array of example microwave energy emitters 120 depicted in FIG. 3 may include additional components and that some of the components described herein may be removed and/or modified without departing from the scopes of the example agent delivery device 110 and the array of example microwave energy emitters 120 disclosed herein.

As shown, the agent delivery device 110 may include an array of agent delivery mechanisms 302 arranged in a direction that is perpendicular to or nearly perpendicular to the scan direction of the agent delivery device 110 denoted by the arrow 212. As used herein, “nearly perpendicular” may be defined to include angles that are within about 5° of being perpendicular, although other angle ranges may be included in the definition. The agent delivery mechanisms 302 may be arranged in offset columns such that the agent delivery mechanisms 302 in one of the columns maybe offset with respect to the agent delivery mechanisms 302 in another one of the columns. The agent delivery mechanisms 302 in the respective columns may be offset with respect to each other such that the agent delivery device 110 may deliver coalescing agent 112 across a large swath of the build material layer 106. In addition, the agent delivery mechanisms 302 may be individually controllable and may have relatively high resolutions, e.g., 600 dpi, 1200 dpi, or the like. By way of particular example, the agent delivery mechanisms 302 may be thermal inkjet printheads, piezoelectric printheads, or the like.

As also shown, the tips 122 of the microwave energy emitters 120, and thus, the microwave energy emitters 120, may be may be arranged in an array including a plurality of columns of microwave energy emitters 120. The columns of microwave energy emitters 120 may be arranged in a direction that is perpendicular to or nearly perpendicular to the scan direction of the agent delivery device 110 denoted by the arrow 212. The microwave energy emitters 120 may be arranged in offset columns such that the microwave energy emitters 120 in one of the columns maybe offset with respect to the microwave energy emitters 120 in another one of the columns. The microwave energy emitters 120 in the respective columns may be offset with respect to each other such that the microwave energy emitters 120 may emit energy across a large swath of the build material layer 106. In addition, the microwave energy emitters 120 may be individually controllable and may have relatively high resolutions. By way of example, the effective radiation diameters of the microwave energy emitters 120 may be greater than around 2 mm and the tips 122 may be in an array and may have a periodicity of greater than around 4 mm.

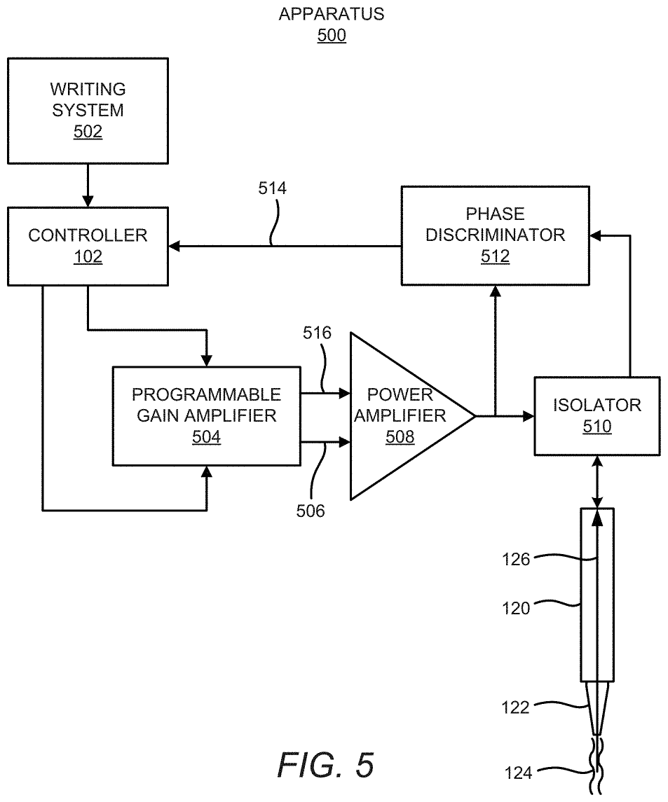

With reference now to FIG. 4, there is shown a diagram of an example microwave energy emitter 120, an example microwave energy source 202, and an example power splitter 204. It should be understood that the example microwave energy emitter 120, the example microwave energy source 202, and the example power splitter 204 depicted in FIG. 3 may include additional components and that some of the components described herein may be removed and/or modified without departing from the scopes of the example microwave energy emitter 120, the example microwave energy source 202, and the example power splitter 204 disclosed herein. It should also be understood that the other microwave energy emitters 120 may have be similarly configured.

As shown, the microwave energy emitter 120 may include a feed 402, which may be a coax feed. The feed 402 may be connected to the power splitter 204 and may receive microwave energy from the microwave energy source 202 via the connection to the power splitter 204. By way of particular example, the microwave energy source 202 may include three magnetron tubes for the array of microwave energy emitters 120 and the power splitter 204 may provide equal amounts of power to each of the microwave energy emitters 120.

The microwave energy emitter 120 may also include a resonator 406, which may equivalently be termed a coax resonator, housed within a protective layer 404 of the coax feed. A gap 408 may be provided between an end of the feed 402 and an end of the resonator 406. As shown, a portion of the protective layer 404 may be positioned in the gap 408, although in other examples, a different type of dielectric material may be provided in the gap 408. The gap 408 may enable the resonator 406 to be capacitively coupled to the feed 402. That is, for instance, the resonator 406 may be coupled to the impedance of the coax with the impedance of the end of the tip 122 having a minimum reflection of energy 124. As a result, the energy 124 may be used for heating the coalescing agent 112 applied on the layer 106 rather than being reflected back to the microwave energy source 202 and dissipated as heat at the microwave energy source 202.

According to examples, the feed 402, the resonator 406, and the tip 122 may be formed of the same type of electrically conductive material or different types of materials with respect to each other. By way of example, the material may include solid copper, stranded copper, copper plated steel wire, and the like.

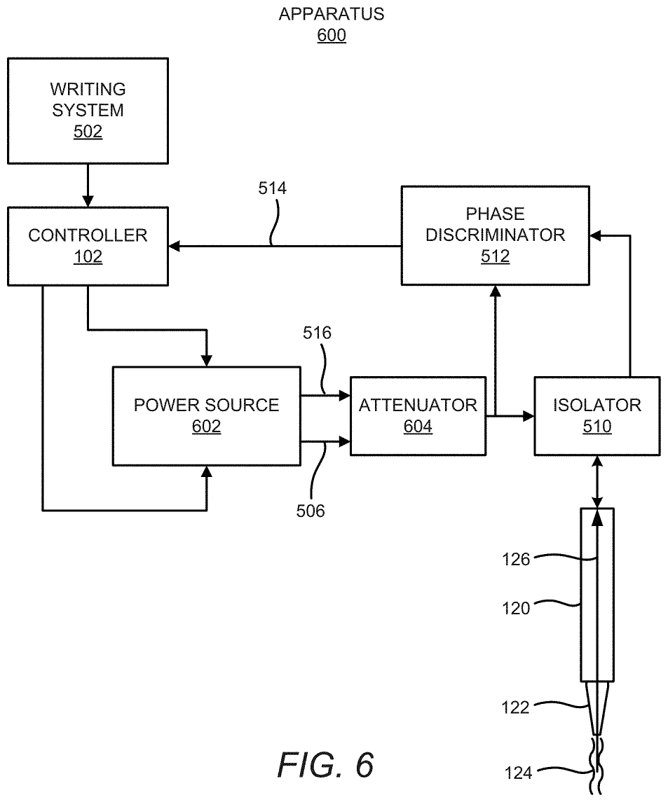

Turning now to FIGS. 5 and 6, there are respectively shown block diagrams of example apparatuses 500 and 600 that may include a microwave energy emitter 120 having a tip 122 to generate a focused microwave energy field for focused build material coalescing and a controller 102 for closed loop feedback control of signal delivery to the microwave energy emitter 120. It should be understood that the example apparatuses 500 and 600 depicted in FIGS. 5 and 6 may include additional components and that some of the components described herein may be removed and/or modified without departing from the scopes of the apparatuses 500 and/or 600 disclosed herein.

As shown in FIG. 5, the apparatus 500 may include the controller 102, which is also depicted in FIGS. 1 and 2. The controller 102 may receive information from a writing system 502. For instance, the writing system 502 may provide local power levels for each of the microwave energy emitters 120 to the controller 102. Particularly, for instance, the writing system 502 may provide desired feedback levels at each of the microwave energy emitter tips 122 to the controller 102. The writing system 502 may also provide control values for mechanical movement, thermal control, agent delivery device control, etc.

The controller 102 may control the programmable gain amplifier 504 to output a first signal 506 corresponding to the local power level for a first microwave energy emitter 120 received from the writing system 502. The programmable gain amplifier 504 may output the first signal 506 at a first power level to a power amplifier 508, which may amplify and output the first signal 506 to an isolator 510. The isolator 510 may supply the first signal 506 to the first microwave energy emitter 120 and the first microwave energy emitter 120 may emit a first microwave energy 124. As discussed herein, energy 126 may be reflected back into the first microwave energy emitter 120 from coalescing agent 112 and/or build material 104 upon which the first microwave energy 124 may be emitted.

As shown, the reflected energy 126 may be directed back through the first microwave energy emitter 120 and to the isolator 510. The isolator 510 may isolate the reflected energy 126 from the first signal 506 and may send the reflected energy 126 to a phase discriminator 512. The phase discriminator 512 may also receive a portion of the first signal 506. In addition, the phase discriminator 512 may determine a difference between a phase of the first signal 506 and a phase of the reflected energy 126. The phase discriminator 512 may generate an energy feedback signal that includes the difference between the phase of the first signal 506 and the phase of the reflected energy 126. The phase discriminator 812 may also communicate the energy feedback signal 514 to the controller 102.

As discussed herein, the controller 102 may determine a power level of a second signal 516 based on the received energy feedback signal 514. That is, the controller 102 may determine the power level signal 516 based on information received from the writing system 502. In addition, the controller 102 may control delivery of the second signal 516 at the determined power level by varying the programmable gain amplifier 504. The second signal 516 may be supplied to the first microwave energy emitter 120 via the power amplifier 508 and the isolator 510. In addition, the feedback loop control based on the reflected energy 126 may be repeated until the build material 104 at the location is coalesced.

The controller 102 may also implement the feedback loop control on the remaining microwave energy emitters 120. That is, a separate programmable gain amplifier 504 and power amplifier 508 may be provided for each of the microwave energy emitters 120 such that the controller 102 may perform feedback loop control on each of the microwave energy emitters 120 individually.

Turning now to FIG. 6, the apparatus 600 includes many of the same components as the apparatus 500. The apparatus 600 differs from the apparatus 500 in that instead of the programmable gain amplifier 504 and power amplifier 508, the apparatus 600 may include a power source 602 and an attenuator 604. Thus, for instance, in order to control delivery of the first signal 506 and the second signal 516, the controller 102 may vary a power output of the power source 602 and or varying the attenuator 604. The controller 102 may also implement the feedback loop control on the remaining microwave energy emitters 120. That is, a separate power sources 602 and attenuators 604 may be provided for each of the microwave energy emitters 120 such that the controller 102 may perform feedback loop control on each of the microwave energy emitters 120 individually.

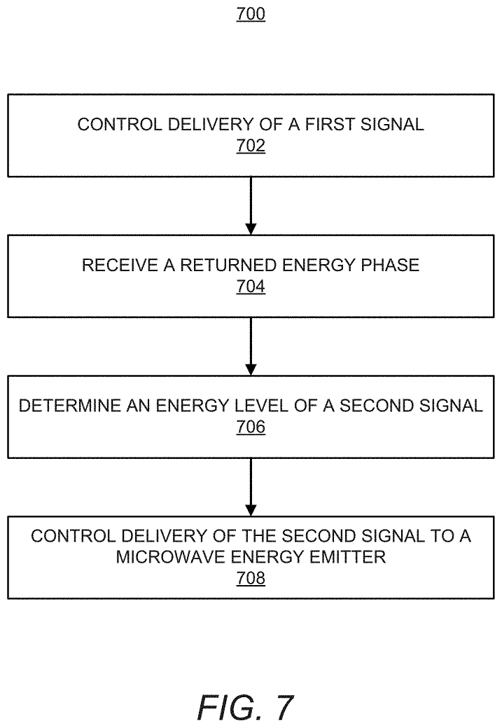

Various manners in which the controller 102 may operate are discussed in greater detail with respect to the method 700 depicted in FIG. 7.

Particularly, FIG. 7 depicts a flow diagram of an example method 700 for closed loop feedback control of signal delivery to a microwave energy emitter 120. It should be understood that the method 700 depicted in FIG. 7 may include additional operations and that some of the operations described therein may be removed and/or modified without departing from the scope of the method 700. The description of the method 700 is made with reference to the features depicted in FIGS. 1-6 for purposes of illustration.

At block 702, the controller 02 may control delivery of a first signal 506 to a first microwave energy emitter 120 of a plurality of microwave energy emitters 120 having tips 122. The first signal 506 may cause the first microwave energy emitter 120 to emit focused microwave energy 124 from the tip 122 of the first microwave energy emitter 120 to a selected location 214 of a build material layer 106. The controller 102 may control delivery of the first signal 506 in any of the manners discussed above with respect to FIGS. 5 and 6.

At block 704, the controller 102 may receive a returned energy phase 514, in which the returned energy phase 514 may include a difference between a phase of a returned signal 126 from the selected location 214 and a phase of the first signal 506. As discussed herein, the phase discriminator may determine and communicate the phase difference to the controller 102.

At block 706, the controller 102 may determine an energy level of a second signal 516 based on the returned energy phase 514. As discussed herein, the controller 102 may also determine the energy level of the second signal 516 based on a thermal mass of the coalescing agent 112 and/or build material 104 at the location 214.

At block 708, the controller 102 may control delivery of the second signal 516 to a microwave energy emitter 120 of the plurality of microwave energy emitters at the determined energy level. The controller 102 may control delivery of the second signal 516 in any of the manners discussed herein with respect to FIGS. 5 and 6. In addition, the microwave energy emitter 120 may be the first microwave energy emitter 120 or a second microwave energy emitter 120. In some examples, both the first microwave energy emitter 120 and a second microwave energy emitter 120 may receive the second signal 516.

The controller 102 may continuously repeat the method 700 until the build material 104 at the location 114 to precisely cause the build material 104 to coalesce.

Some or all of the operations set forth in the method 700 may be included as utilities, programs, or subprograms, in any desired computer accessible medium. In addition, the method 700 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM. EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
an agent delivery device to deliver a coalescing agent to a selected location of a build material layer;
a plurality of microwave energy emitters, each of the microwave energy emitters including a tip to generate a focused microwave energy field onto a respective area near the tip; and
a controller to:
control delivery of a first signal to a first microwave energy emitter of the plurality of microwave energy emitters;
receive an energy feedback signal corresponding to energy reflected back into the first microwave energy emitter;
determine, based on the received energy feedback signal, a power level of a second signal to be delivered to a microwave energy emitter of the plurality of microwave energy emitters; and
control delivery of the second signal at the determined power level to the microwave energy emitter.

2. The apparatus of claim 1, wherein the plurality of microwave energy emitters is to be scanned in a scan direction, wherein the microwave energy emitter comprises a second microwave energy emitter of the plurality of microwave energy emitters, and wherein the second microwave energy emitter is positioned downstream of the first microwave energy emitter with respect to the scan direction.

3. The apparatus of claim 1, wherein each of the plurality of microwave energy emitters includes a resonator and a coaxial feed, wherein the resonator is capacitively coupled to the coaxial feed and the tip is attached to the resonator.

4. The apparatus of claim 1, further comprising:
an isolator to receive the reflected energy from the first microwave energy emitter;
a phase discriminator to:
receive the reflected energy from the isolator; and
determine the energy feedback signal to be a difference between a phase of the first signal and a phase of the reflected energy; and
communicate the energy feedback signal to the controller.

5. The apparatus of claim 1, wherein the controller is further to determine the power level of the second signal based on a thermal mass of the selected location.

6. The apparatus of claim 1, further comprising:
a power amplifier to supply the signal to the microwave energy emitter;
a programmable gain amplifier to supply the signal to the power amplifier; and
wherein the controller is further to control delivery of the second signal at the determined power level by varying the programmable gain amplifier.

7. The apparatus of claim 1, further comprising:
an attenuator to supply the signal to the microwave energy emitter;
a microwave power source; and
wherein the controller is further to control delivery of the second signal at the determined power level by varying a power output of the microwave power source, by varying the attenuator, or both.

8. A three dimensional (3D) fabrication system comprising:
an agent delivery device;
an array of microwave energy emitters, each of the microwave energy emitters including a tip; and
a controller to:
control the agent delivery device to deliver a coalescing agent onto a location of a build material layer including build material that is to be coalesced;
control a first microwave energy emitter of the plurality of microwave energy emitters to emit focused microwave energy from the tip of the first microwave energy emitter through delivery of a first signal to the first microwave energy emitter;
receive a difference in phase of the first signal and a reflected signal from the location; and
cause a second signal to be supplied to a microwave energy emitter of the plurality of microwave energy emitters based on the determined difference, the second signal having a power level based on the determined difference.

9. The 3D fabrication system of claim 8, wherein the microwave energy emitter comprises the first microwave energy emitter or a second microwave energy emitter of the plurality of microwave energy emitters.

10. The 3D fabrication system of claim 8, wherein the first microwave energy emitter is to receive the reflected signal from the location, the 3D fabrication system further comprising:
an isolator to receive the reflected signal from the first microwave energy emitter;
a phase discriminator to:
receive the reflected signal from the isolator; and
determine the difference in phase of the first signal and the reflected signal; and
communicate the determined difference to the controller.

11. The 3D fabrication system of claim 8, further comprising:
a power amplifier to supply the second signal to the microwave energy emitter;
a programmable gain amplifier to supply the second signal to the power amplifier; and
wherein the controller is further to set the power level of the second signal delivered to the microwave energy emitter by varying the programmable gain amplifier.

12. The 3D fabrication system of claim 8, further comprising:
an attenuator to supply the second signal to the microwave energy emitter;
a microwave power source; and
wherein the controller is further to vary the power level of the second signal delivered to the microwave energy emitter by varying a power output of the microwave power source, by varying the attenuator, or both.

13. A method comprising:
controlling, by a controller, delivery of a first signal to a first microwave energy emitter of a plurality of microwave energy emitters having tips, the first signal causing the first microwave energy emitter to emit focused microwave energy from the tip of the first microwave energy emitter to a selected location of a build material layer;
receiving, by the controller, a returned energy phase, the returned energy phase comprising a difference between a phase of a returned signal from the selected location and a phase of the first signal;
determining, by the controller, an energy level of a second signal based on the returned energy phase; and
controlling, by the controller, delivery of the second signal to a microwave energy emitter of the plurality of microwave energy emitters at the determined energy level.

14. The method of claim 13, wherein determining the energy level of the second signal further comprises determining the energy level based on a thermal mass of the selected location.

15. The method of claim 13, wherein controlling delivery of the second signal further comprises controlling one of a programmable gain amplifier, a microwave power source, and an attenuator to deliver the second signal at the determined energy level.
